(19) United States
(12) Patent Application Publication
(10) Pub. No.: US 2025/0051576 A1
(43) Pub. Date: Feb. 13, 2025

(54) BIODEGRADEABLE COMPOSITE AND METHOD OF PREPARATION THEREOF

(71) Applicant: Nano and Advanced Materials Institute Limited, Hong Kong (CN)

(72) Inventors: Wei LI, Hong Kong (CN); Jianli WANG, Hong Kong (CN); Yeuk Tin LAU, Hong Kong (CN); Sui Han SIN, Hong Kong (CN)

(21) Appl. No.: 18/768,565

(22) Filed: Jul. 10, 2024

Related U.S. Application Data
(60) Provisional application No. 63/516,573, filed on Jul. 31, 2023.

(51) Int. Cl. C08L 97/02; C08K 3/26; C08K 5/526; C08K 9/04; C08K 13/06; C08L 67/04

(52) U.S. Cl. CPC C08L 97/02; C08K 13/06; C08L 67/04; C08K 2003/265; C08K 5/526; C08K 9/04; C08L 2201/06; C08L 2201/08; C08L 2205/035; C08L 2205/08; C08L 2205/24; C08L 2312/00

(57) ABSTRACT

Polylactic acid (PLA)/biomass composite including: polylactic acid (PLA), a biomass material, a compatibilizer, a crosslinker, a chain extender, an antioxidant, and a nucleating agent, wherein the PLA, the biomass material, the compatibilizer, the crosslinker, the chain extender, the antioxidant, and the nucleating agent are present in the PLA/biomass composite at a concentration of 30-60% wt/wt, 20-70% wt/wt, 5-20% wt/wt, 0.1-2% wt/wt, 0.1-1% wt/wt, 0.1-1% wt/wt, and 1-10% wt/wt, respectively.

### CROSS-REFERENCE TO RELATED APPLICATIONS

The present application claims priority from U.S. Provisional Patent Application No. 63/516,573, filed on Jul. 31, 2023, which is hereby incorporated by reference in its entirety.

### TECHNICAL FIELD

This disclosure relates to a polylactic acid (PLA)/biomass composite having increased biomass concentration and improved mechanical properties and a method of preparation thereof.

### BACKGROUND

The manufacture of PLA/biomass composite is a popular method for carbon reduction, wherein one or more high carbon footprint plastic polymer is replaced by low carbon biomass materials, e.g., agricultural waste like waste wood, bamboo, hemp, etc. However, PLA/biomass composites suffer from deterioration of mechanical properties, which highly limit their applications. For example, when PLA is mixed with biobased materials at higher portion like ≥50% content, the tensile strength and flexural strength decreased from 60 MPa to 22 MPa and 94 MPa to 36 MPa, respectively. The reason for such cliff-like deterioration of mechanical properties is believed to be due to incompatibility among biobased materials and the plastic polymer. Due to the difference in the polarity of PLA and biomass, they cannot be effectively blended or crosslinked, which results in poor mixing during melt extrusion processes, resulting in poor dispersion and interface between the biomass and PLA polymer chains and the biomass and consequently poor mechanical properties. Efforts to improve dispersion and mixing of PLA and the biomass using commercially available compatibilizers. However, due to marked differences in functional-group density between PLA and biomass materials (>150 times more), compatibilizers have a strong tendency to mainly react with biomass materials and form “biomass material-compatibilizer-biomass material” cluster and eventually the dispersion is uneven in the composite, come up with an improved but still unacceptable mechanical properties.

There thus exists a need for improved PLA/biomass composite that overcome at least some of the disadvantages mentioned above.

### SUMMARY

Provided herein is a reactive homogenization that can remarkably increase the amount of biomass filler from 30% to more than 50%, while providing improved mechanical properties and reducing the high material cost of biodegradable plastic like PLA. Reactive homogenization is a two-step melt-extrusion process. As PLA is a typical thermoplastic polyester plastic, with active functional groups at the end points of polymer chains, which can be utilized to form a compatibilizing pellet. An octopus-shape functional group promoter with a cyclic compound body and multiple branches of epoxy groups is designed for forming the network-branched compatibilizing pellet. In the first step, the terminal hydroxyl functional group of the PLA polymer chains are reacted with an epoxy crosslinker thereby forming the compatibilizing pellet. In the second step, the biomass material is combined with the compatibilizing pellet resulting in the crosslinking of the biomass and the compatibilizing pellet thereby forming the PLA/biomass composite.

In a first aspect, provided herein is a polylactic acid (PLA)/biomass composite comprising: polylactic acid (PLA), a biomass material, a compatibilizer, a crosslinker, a chain extender, an antioxidant, and a nucleating agent, wherein the PLA, the biomass material, the compatibilizer, the crosslinker, the chain extender, the antioxidant, and the nucleating agent are present in the PLA/biomass composite at a concentration of 30-60% wt/wt, 20-70% wt/wt, 5-20% wt/wt, 0.1-3% wt/wt, 0.1-2% wt/wt, 0.1-1% wt/wt, and 1-10% wt/wt, respectively.

In certain embodiments, the biomass material is selected from the group consisting of wood, bamboo, corncob, and combinations thereof.

In certain embodiments, the compatibilizer is selected from polylactic acid grafted maleic anhydride (PLA-g-MAH); polybutylene adipate terephthalate grafted maleic anhydride (PBAT-g-MAH); a self-synthesized network-branched compatibilizing pellet represented by the by the chemical structure I or II:

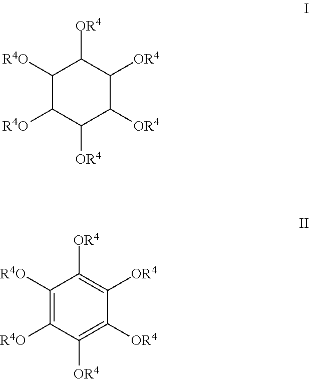

or a pharmaceutically acceptable salt thereof, wherein: R⁴ for each instance is independently hydrogen, a moiety of Formula III, or a moiety of Formula IV:

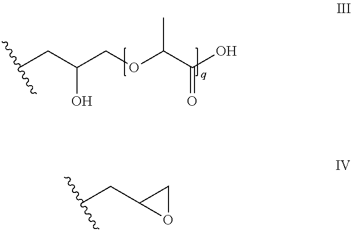

wherein q is a whole number selected from 650-6,500, with the proviso that at least 1 R⁴ is the moiety of Formula III and at least two R⁴ are the moiety of Formula IV; and combinations thereof.

In certain embodiments, the crosslinker is selected from the group consisting of epoxidized soybean oil (ESO), neopentyl glycol diglycidyl ether (NGDE), diethylene glycol diglycidyl ether (DGDE), 1,4-butanediol diglycidyl ether (BDE), diglycidyl ether (DE), tannic acid (TA), gallic acid (GA), 3,4-dihydroxybenzaldehyde (DB), pyrogallol, and combinations thereof.

In certain embodiments, the chain extender is selected from the group consisting of:

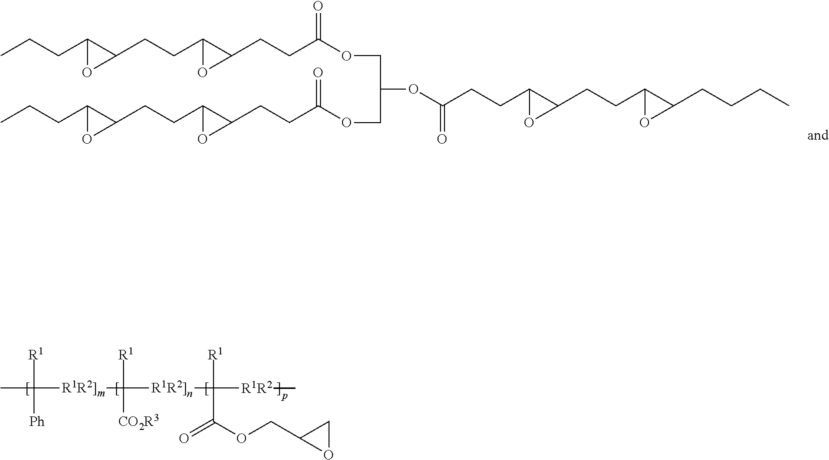

wherein each of R¹ and R² is independently H, CH₃, or alkyl; R³ is alkyl, and each of m, n, and p is independently 1-20; and combinations thereof.

In certain embodiments, the antioxidant is selected from the group consisting of:

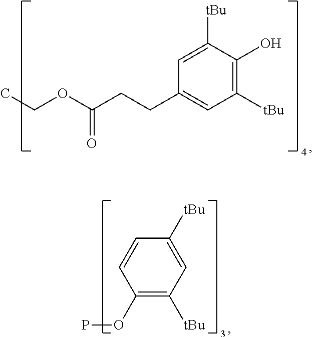

and combinations thereof.

In certain embodiments, the nucleating agent is selected from the group consisting of: sebacic acid diphenyl dihydrazide, montmorillonite, calcium carbonate, and combinations thereof.

In certain embodiments, the crosslinker is selected from the group consisting of epoxidized soybean oil (ESO), neopentyl glycol diglycidyl ether (NGDE), diethylene glycol diglycidyl ether (DGDE), 1,4-butanediol diglycidyl ether (BDE), diglycidyl ether (DE), tannic acid (TA), gallic acid (GA), 3,4-dihydroxybenzaldehyde (DB), pyrogallol, and combinations thereof; the chain extender is selected from the group consisting of:

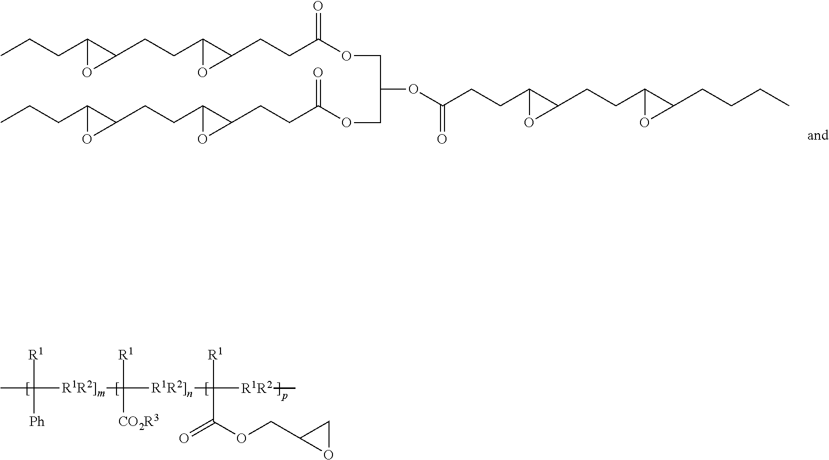

wherein each of R¹ and R² is independently H, CH₃, or alkyl; R³ is alkyl, and each of m, n, and p is independently 1-20; and combinations thereof;
the antioxidant is selected from the group consisting of:

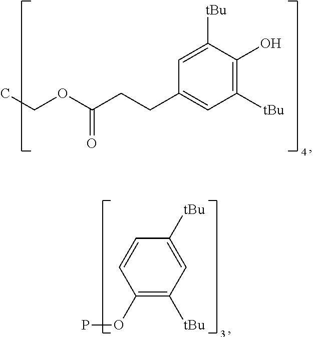

and combinations thereof; and the nucleating agent is selected from the group consisting of: sebacic acid diphenyl dihydrazide, montmorillonite, calcium carbonate, and combinations thereof.

In certain embodiments, the PLA, the biomass material, the compatibilizer, the crosslinker, the chain extender, the antioxidant, and the nucleating agent are present in the PLA/biomass composite at a concentration of 30-60% wt/wt, 21.6-49.5% wt/wt, 8-12% wt/wt, 1.2-2% wt/wt, 0.6-1% wt/wt, 0.5-1% wt/wt, and 4-9% wt/wt, respectively.

In certain embodiments, the compatibilizer is a self-synthesized network-branched compatibilizing pellet represented by the by the chemical structure I or II:

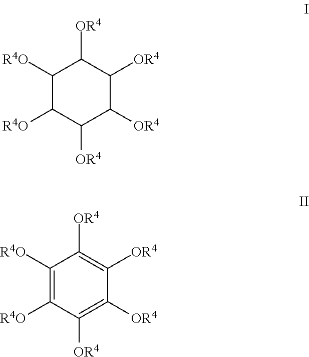

or a pharmaceutically acceptable salt thereof, wherein: R⁴ for each instance is independently hydrogen, a moiety of Formula III, or a moiety of Formula IV:

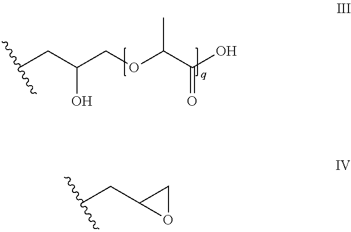

wherein q is a whole number selected from 650-6,500, with the proviso that at least 1 R⁴ is the moiety of Formula III and at least two R⁴ are the moiety of Formula IV; and combinations thereof;
the crosslinker comprises tannic acid, gallic acid, 3,4-dihydroxybenzaldehyde, and pyrogallol; the chain extender comprises:

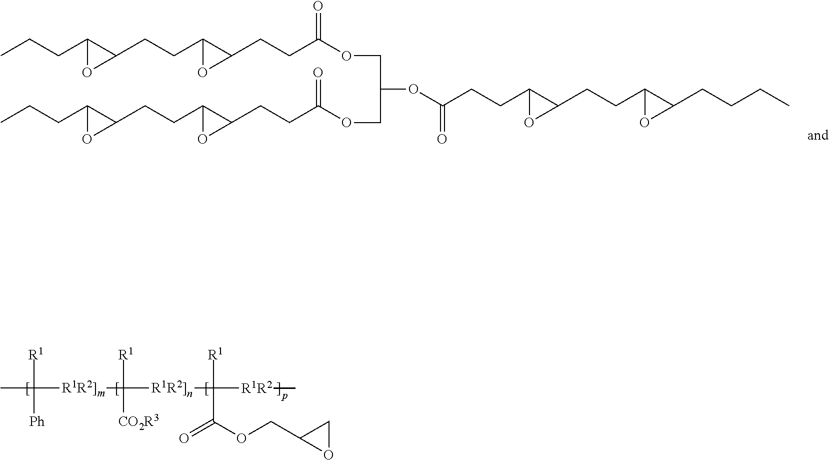

wherein each of R¹ and R² is independently H, CH₃, or alkyl; R³ is alkyl, and each of m, n, and p is independently 1-20;
the antioxidant comprises:

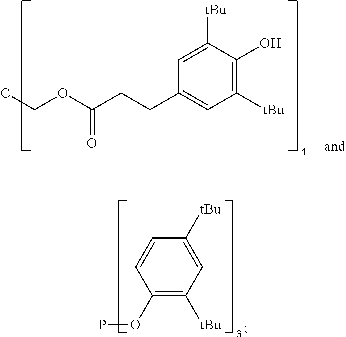

and the nucleating agent comprises sebacic acid diphenyl dihydrazide, montmorillonite, and calcium carbonate.

In certain embodiments, the PLA, the biomass material, the compatibilizer, the crosslinker, the chain extender, the antioxidant, and the nucleating agent are present in the PLA/biomass composite at a concentration of about 50% wt/wt, about 32% wt/wt, about 8% wt/wt, about 1.3% wt/wt, about 1% wt/wt, about 0.7% wt/wt, and about 7% wt/wt, respectively.

In a second aspect, provided herein is a method of preparing the PLA/biomass composite described herein, the method comprising: melt blending PLA, the biomass material, the compatibilizer, the crosslinker, the chain extender, the antioxidant, and the nucleating agent; optionally pelletizing and optionally drying thereby forming the PLA/biomass composite.

In certain embodiments, the biomass material is selected from the group consisting of wood, bamboo, corncob, and combinations thereof.

In certain embodiments, the compatibilizer is selected from polylactic acid grafted maleic anhydride (PLA-g-MAH); polybutylene adipate terephthalate grafted maleic anhydride (PBAT-g-MAH); a self-synthesized network-branched compatibilizing pellet represented by the by the chemical structure I or II:

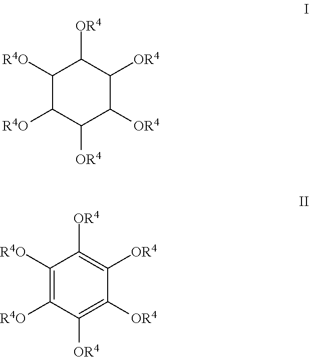

or a pharmaceutically acceptable salt thereof, wherein: R⁴ for each instance is independently hydrogen, a moiety of Formula III, or a moiety of Formula IV:

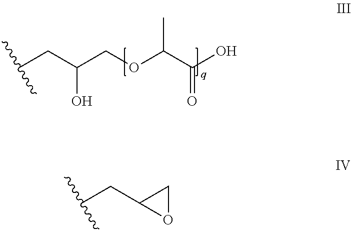

wherein q is a whole number selected from 650-6,500, with the proviso that at least 1 R⁴ is the moiety of Formula III and at least two R⁴ are the moiety of Formula IV; and combinations thereof.

In certain embodiments, the crosslinker is selected from the group consisting of epoxidized soybean oil (ESO), neopentyl glycol diglycidyl ether (NGDE), diethylene glycol diglycidyl ether (DGDE), 1,4-butanediol diglycidyl ether (BDE), diglycidyl ether (DE), tannic acid (TA), gallic acid (GA), 3,4-dihydroxybenzaldehyde (DB), pyrogallol, and combinations thereof.

In certain embodiments, the chain extender is selected from the group consisting of:

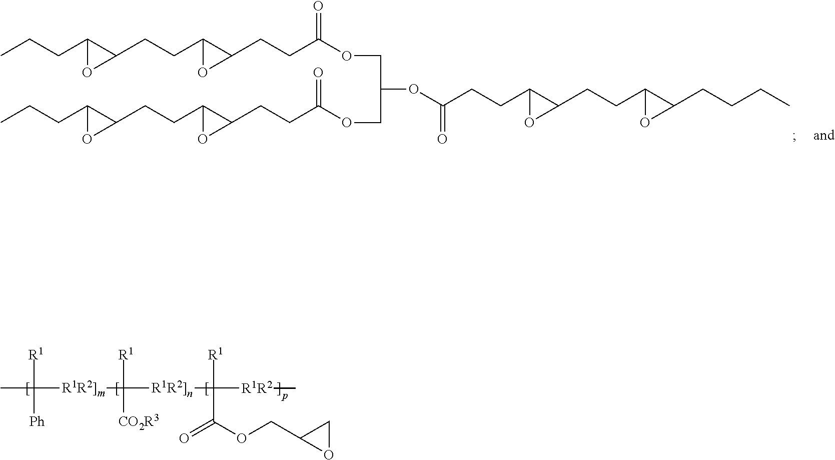

wherein each of R¹ and R² is independently H, CH₃, or alkyl; R³ is alkyl, and each of m, n, and p is independently 1-20; and combinations thereof.

In certain embodiments, the method further comprises: contacting PLA with a compound of Formula V or VI:

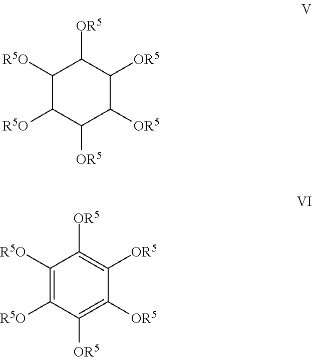

or a pharmaceutically acceptable salt thereof, wherein: R⁵ for each instance is independently hydrogen or a moiety of Formula IV:

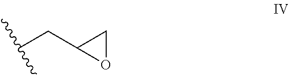 [SMILES: *CC1CO1]

with the proviso that at least 3 R⁵ is the moiety of Formula IV, thereby forming the compatibilizer, wherein the compatibilizer is a self-synthesized network-branched compatibilizing pellet represented by the by the chemical structure I or II:

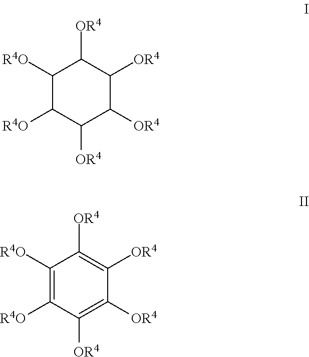

or a pharmaceutically acceptable salt thereof, wherein R⁴ for each instance is independently hydrogen, a moiety of Formula III, or a moiety of Formula IV:

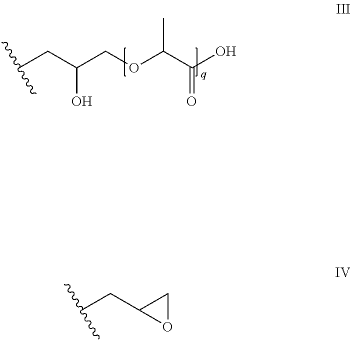

wherein q is a whole number selected from 650-6,500, with the proviso that at least 1 R⁴ is the moiety of Formula III and at least two R⁴ are the moiety of Formula IV.

In certain embodiments, the method comprises melt blending PLA and the compound of Formula V or VI, thereby forming the self-synthesized network-branched compatibilizing pellet; and melt blending the self-synthesized network-branched compatibilizing pellet with PLA, the biomass material, crosslinker, antioxidant, and nucleating agent, optionally pelletizing, and optionally drying thereby forming the PLA/biomass composite.

In certain embodiments, the PLA and the compound of Formula V or VI are melt extruded at 160-190° C. thereby forming the network-branched compatibilizing pellet; and the network-branched compatibilizing pellet, PLA, the biomass material, antioxidant, and nucleating agent are melt extruded at 190-220° C.; optionally pelletizing and optionally drying thereby forming the PLA/biomass composite.

In certain embodiments, the crosslinker comprises tannic acid, gallic acid, 3,4-dihydroxybenzaldehyde, and pyrogallol; the chain extender comprises:

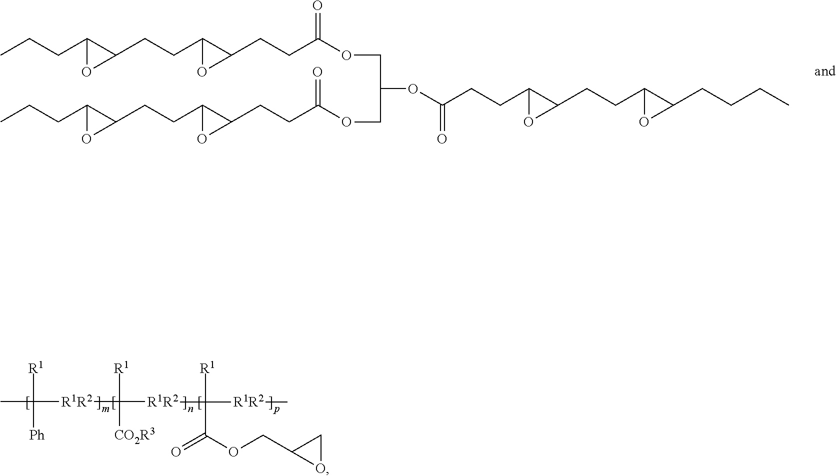

wherein each of R¹ and R² is independently H, CH₃, or alkyl; R³ is alkyl, and each of m, n, and p is independently 1-20;
the antioxidant comprises:

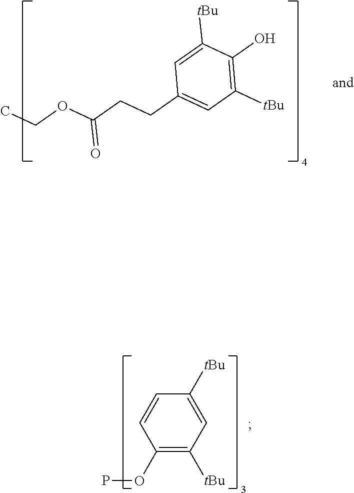

and the nucleating agent comprises sebacic acid diphenyl dihydrazide, montmorillonite, and calcium carbonate.

### DETAILED DESCRIPTION

Throughout the present disclosure, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the present invention.

Furthermore, throughout the present disclosure and claims, unless the context requires otherwise, the word “include” or variations such as “includes” or “including”, will be understood to imply the inclusion of a stated integer or group of integers, but not the exclusion of any other integer or group of integers.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10%, ±7%, ±5%, ±3%, ±1%, or ±0% variation from the nominal value unless otherwise indicated or inferred.

In the specification, the term “alkyl” may refer to a linear alkyl group, a branched chain alkyl group, or a cyclic alkyl group. The number of carbons in the alkyl group may be 1 to 50, 1 to 30, 1 to 20, 1 to 10, or 1 to 6.

Provided herein is a PLA/biomass composite comprising: polylactic acid (PLA), a biomass material, a compatibilizer, a crosslinker, a chain extender, an antioxidant, and a nucleating agent, wherein the PLA, the biomass material, the compatibilizer, the crosslinker, the chain extender, the antioxidant, and the nucleating agent are present in the PLA/biomass composite at a concentration of 30-60% wt/wt, 20-70% wt/wt, 5-20% wt/wt, 0.1-2% wt/wt, 0.1-1% wt/wt, 0.1-1% wt/wt, and 1-10% wt/wt, respectively.

The PLA can have an average molecular weight of 50,000-500,000 amu, 85,000-500,000 amu, 150,000-500,000 amu, 250,000-500,000 amu, 400,000-500,000 amu, 85,000-400,000 amu, 85,000-250,000 amu, 85,000-150,000 amu, 150,000-400,000 amu, or 250,000-400,000 amu. The PLA can be present in the PLA/biomass composite at a concentration of 30-60% wt/wt, 35-60% wt/wt, 40-60% wt/wt, 45-60% wt/wt, 50-60% wt/wt, 55-60% wt/wt, 30-55% wt/wt, 30-50% wt/wt, 30-45% wt/wt, 30-40% wt/wt, 30-35% wt/wt, 35-55% wt/wt, 40-50% wt/wt, 45-50% wt/wt, or 40-45% wt/wt. In certain embodiments, the PLA is present in the PLA/biomass composite at a concentration of about 30% wt/wt, about 40% wt/wt, about 45% wt/wt, about 50% wt/wt, or about 60% wt/wt.

The type of biomass material is not particularly limited and can be any cellulosic containing biomass material. In certain embodiments, the biomass material is selected from the group consisting of paper, paper products, paper waste, wood, pressed wood, wood sawdust, agricultural waste, silage, grass, rice husk, cotton, jute, spinning, linen, bamboo, sisal, straw, corncob, corn straw, millet, alfalfa, hay, coconut husk fiber, cotton, synthetic cellulose, seagrass, algae and mixtures thereof. In certain embodiments, the biomass material is wood, bamboo, corncob, or a mixture thereof.

The biomass material can be present in the PLA/biomass composite at a concentration of 20-70% wt/wt, 25-70% wt/wt, 30-70% wt/wt, 35-70% wt/wt, 40-70% wt/wt, 45-70% wt/wt, 50-70% wt/wt, 55-70% wt/wt, 60-70% wt/wt, 65-70% wt/wt, 20-65% wt/wt, 20-60% wt/wt, 20-55% wt/wt, 20-50% wt/wt, 20-45% wt/wt, 20-40% wt/wt, 20-35% wt/wt, 20-30% wt/wt, 20-25% wt/wt, 25-65% wt/wt, 30-60% wt/wt, 35-55% wt/wt, 40-50% wt/wt, 45-50% wt/wt, 40-45% wt/wt, 21.6-49.5% wt/wt, 21.6-40.8% wt/wt, 21.6-37.3% wt/wt, 21.6-32% wt/wt, 32-49.5% wt/wt, 37.3-49.5% wt/wt, 32-49.5% wt/wt, 37.3-49.5% wt/wt, 40.8-49.5% wt/wt, 32-40.8% wt/wt, 37.3-40.8% wt/wt, or 37.3-40.8% wt/wt. In certain embodiments, the biomass material is present in the PLA/biomass composite at a concentration of about 21.6% wt/wt, about 32% wt/wt, about 37.3% wt/wt, about 40.8% wt/wt, or about 49.5% wt/wt.

The biomass material can have a particle size of 200 mesh, 175 mesh, 150 mesh, 125 mesh, 100 mesh, or 80 mesh. In certain embodiments, the biomass material can have a particle size of 25-200 mesh, 50-200 mesh, 80-200 mesh, 80-175 mesh, 80-150 mesh, 80-125 mesh, 80-100 mesh, 100-200 mesh, 125-200 mesh, 150-200 mesh, 175-200 mesh, 125-175 mesh, 125-150 mesh, or 150-175 mesh.

The particle size of the biomass material can optionally be reduced prior to use in the preparation of the compositions described herein.

There are various known methods for controlling the particle size of substances, including reduction by comminution or de-agglomeration by milling and/or sieving. Exemplary methods for particle reduction include, but are not limited to jet milling, hammer milling, compression milling and tumble milling processes (e.g., ball milling). Particle size control parameters for these processes are well understood by the person skilled in the art. For example, the particle size reduction achieved in a jet milling process is controlled by adjusting a number of parameters, the primary ones being mill pressure and feed rate. In a hammer mill process, the particle size reduction is controlled by the feed rate, the hammer speed and the size of the opening in the grate/screen at the outlet. In a compression mill process, the particle size reduction is controlled by the feed rate and amount of compression imparted to the material (e.g., the amount of force applied to compression rollers).

The compatibilizer can be selected from the group consisting of poly(ethylene-co-methyl acrylate-co-glycidyl methacrylate) (EGMA), PLA-g-MAH, PBAT-g-MAH and a network-branched compatibilizing pellet, wherein the network-branched compatibilizing pellet is represented by the chemical structure I or II:

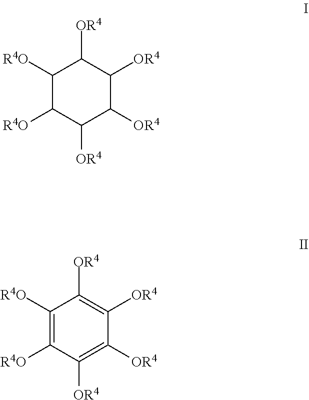

or a pharmaceutically acceptable salt thereof wherein: R⁴ for each instance is independently hydrogen, a moiety of Formula III, or a moiety of Formula IV:

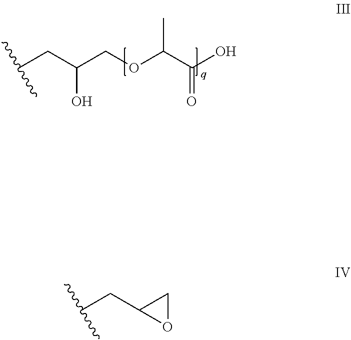

wherein q is a whole number selected from 650-6,500, with the proviso that at least 1 R⁴ is the moiety of Formula III and at least two R⁴ are the moiety of Formula IV. In certain embodiments, R⁴ for each instance is independently a moiety of Formula III or a moiety of Formula IV. In certain embodiments, 1-5, 1-4, 1-3, 1-2, 2-3, 2-5, 3-5, 3-4, or 4-5 R⁴ are the moiety of Formula III. In certain embodiments, 2-3, 2-4, 2-5 R⁴ are the moiety of Formula IV. In certain embodiments, the network-branched compatibilizing pellet is represented by the chemical structure I, wherein 1-2 R⁴ are the moiety of Formula III; and 4-5 R⁴ are the moiety of Formula IV. In certain embodiments, the network-branched compatibilizing pellet is represented by the chemical structure II, wherein 2-3 R⁴ are the moiety of Formula III; and 5-6 R⁴ are the moiety of Formula IV.

In certain embodiments, the average molecular weight of PBAT-g-MAH is about 120,000 to about 300,000 amu and the average molecular weight of PLA-g-MAH is about 100,000.

The PLA/biomass composite can comprise 1, 2, 3, 4, 5, or more compatibilizers.

The compatibilizer can be present in the PLA/biomass composite at a concentration of 5-20% wt/wt, 10-20% wt/wt, 15-20% wt/wt, 5-15% wt/wt, 5-10% wt/wt, 5-15% wt/wt, 10-15% wt/wt, 7-12% wt/wt, 8-12% wt/wt, 10-12% wt/wt, 7-10% wt/wt, or 7-8% wt/wt. In certain embodiments, the compatibilizer is present in the PLA/biomass composite at a concentration of about 7% wt/wt, about 8% wt/wt, about 10% wt/wt, or about 12% wt/wt.

The crosslinker can be an epoxidized naturally occurring oil, such as epoxidized olive oil, linseed oil, soybean oil, palm oil, peanut oil, coconut oil, seaweed oil, or cod liver oil, NGDE, DGDE, BDE, DE, TA, GA, DB, pyrogallol, or a mixture thereof.

The PLA/biomass composite can comprise 1, 2, 3, 4, 5, or more crosslinkers.

The crosslinker can be present in the PLA/biomass composite at a concentration of 0.1-3% wt/wt, 0.5-3% wt/wt, 1.0-3% wt/wt, 1.0-2.5% wt/wt, 1.0-2% wt/wt, 1.5-2% wt/wt, 1.0-1.5% wt/wt, 1.2-2% wt/wt, 1.3-2% wt/wt, 1.7-2% wt/wt, 1.8-2% wt/wt, 1.2-1.8% wt/wt, 1.2-1.7% wt/wt, 1.2-1.3% wt/wt, 1.3-1.8% wt/wt, or 1.2-1.7% wt/wt. In certain embodiments, the crosslinker is present in the PLA/biomass composite at a concentration of about 1.2% wt/wt, about 1.3% wt/wt, about 1.7% wt/wt, about 1.8% wt/wt, or about 2% wt/wt.

The chain extender can be a polymeric oligomer comprising glycidyl groups incorporated as side chains; epoxy-functional, styrene-acrylic polymers, such as those sold by BASF under the tradename “Joncryl™”, which are described in U.S. Pat. No. 6,984,694, which is herein incorporated by reference. Exemplary chain extenders sold under the Joncryl™ tradename include, but are not limited to, Joncryl™ ADR-4368, Joncryl™ ADR-4368C, Joncryl™ ADR4300, and Joncryl™ ADR4468. Joncryl™ ADR4300 has the chemical formula:

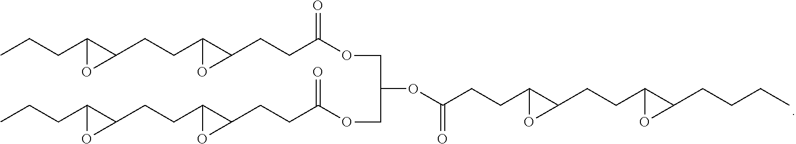 [SMILES: CCCCC1OC1CCC1OC1CCC(=O)OC(COC(=O)CCC1OC1CCC1OC1CCC)COC(=O)CCC1OC1CCC1OC1CCC]

Joncryl™ ADR-4368C, Joncryl™ ADR4368, and Joncryl™ ADR4468, have the general chemical formula:

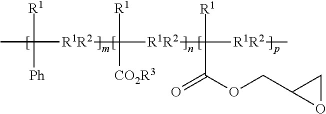

wherein each of R¹ and R² is independently H, CH₃, or alkyl; R³ is alkyl, and each of m, n, and p is independently 1-20. JONCRYL™ ADR-4368 has the following properties: Mₙ<3,000; PDI>3; epoxy equivalent weight (EEW)=285±15 g/mol; and T_{g}=55° C.

The PLA/biomass composite can comprise 1, 2, 3, or more chain extenders.

The chain extender can be present in the PLA/biomass composite at a concentration of 0.1-2% wt/wt, 0.5-2% wt/wt, 1.0-2% wt/wt, 1.5-2% wt/wt, 1.0-1.5% wt/wt, 1.2-2% wt/wt, 0.1-1.5% wt/wt, 0.1-1% wt/wt, 0.5-1.5% wt/wt, 0.5-1% wt/wt, 0.6-1% wt/wt, or 0.1-0.6% wt/wt. In certain embodiments, the chain extender is present in the PLA/biomass composite at a concentration of about 0.6% wt/wt or about 1% wt/wt.

The antioxidant can be a phenol-based antioxidant. Exemplary antioxidants, include, but are not limited to, butylated hydroxytoluene, Irganox®1010, Irganox® 1076, Irganox® 1098, Irgafos® 168 or Irganox® B 225, and the like. In certain embodiments, the antioxidant is selected from the group consisting of:

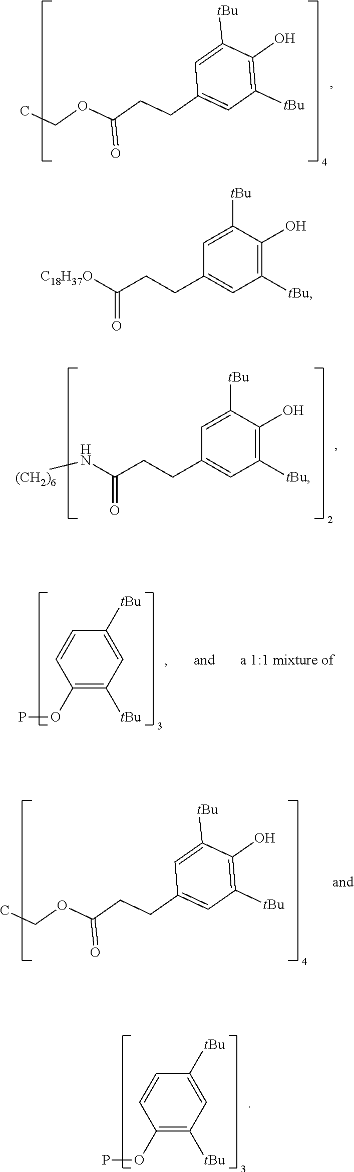

The PLA/biomass composite can comprise 1, 2, 3, or more antioxidants.

The antioxidant can be present in the PLA/biomass composite at a concentration of 0.1-2% wt/wt, 0.1-1.5% wt/wt, 0.1-1% wt/wt, 0.1-0.5% wt/wt, 0.5-2% wt/wt, 1-2% wt/wt, 1.5-2% wt/wt, 1-1.5% wt/wt, 0.5-1% wt/wt, 0.7-1% wt/wt, or 0.5-0.7% wt/wt. In certain embodiments, the antioxidant is present in the PLA/biomass composite at a concentration of about 0.5% wt/wt, about 0.7% wt/wt, or about 1% wt/wt.

In certain embodiments, the nucleating agents is montmorillonite, calcium carbonate, talcum powder, hydrotalcite, N,N′, N″-tricyclohexyl-1, 3, 5-benzenetricarboxamide, zinc phenylphosphonate, sebacic acid diphenyl dihydrazide (TMC300), adipic acid diphenyl dihydrazide, or a mixture thereof.

The PLA/biomass composite can comprise 1, 2, 3, or more nucleating agents.

The nucleating agents can be present in the PLA/biomass composite at a concentration of 1-10% wt/wt, 2-10% wt/wt, 3-10% wt/wt, 4-10% wt/wt, 5-10% wt/wt, 6-10% wt/wt, 7-10% wt/wt, 8-10% wt/wt, 9-10% wt/wt, 1-9% wt/wt, 1-8% wt/wt, 1-7% wt/wt, 1-6% wt/wt, 1-5% wt/wt, 1-4% wt/wt, 1-3% wt/wt, 1-2% wt/wt, 4-9% wt/wt, 4-7% wt/wt, 4-5% wt/wt, 5-9% wt/wt, or 7-9% wt/wt. In certain embodiments, the nucleating agents is present in the PLA/biomass composite at a concentration of about 4% wt/wt, about 5% wt/wt, about 7% wt/wt, or about 9% wt/wt.

Also provided herein is a method for preparing the PLA/biomass composite described herein, the method comprising: melt blending PLA, the biomass material, the compatibilizer, the crosslinker, the chain extender, the antioxidant, and the nucleating agent; optionally pelletizing and optionally drying thereby forming the PLA/biomass composite.

Melt blending the PLA, the biomass material, the compatibilizer, crosslinker, the chain extender, the antioxidant, and the nucleating agent thereby can be melt blended using any conventional method. In certain embodiments, melt blending may be conducted in machines such as, single, twin, or multiple screw extruders, Buss kneader, Eirich mixers, Henschel, helicones, Ross mixer, Banbury, roll mills, molding machines, such as injection molding machines, vacuum forming machines, blow molding machines, or the like, or combinations comprising two or more the foregoing machines.

In certain embodiments, melt blending is achieved on either a mixer or a single/twin-screw extruder operated within a proper processing temperature range according to different melting temperatures of the PLA and other main components for modifying the same, e.g., from 150 to 250° C. The melt mixing duration can range from 60s to 600s. The selection of the appropriate melt blending conditions is well within the skill of a person of ordinary skill in the art.

After melt blending, the resulting PLA/biomass composite can then be optionally pelletized. The thus obtained pelletized PLA/biomass composite can then be subjected to injection molding directly to reform into an article with a desired shape and dimension. Apart from injection molding, other molding methods, such as profile extrusion, blow molding, blow filming, film casting, spinning and over-molding of the bacteria repellant polymer composite on a plastic substrate can also be applied to reform into an article. The PLA/biomass composite can be molded into a shape such as a pellet, but also semi-finished product or an article.

In certain embodiments, the method further comprises contacting PLA with a compound of Formula V or VI:

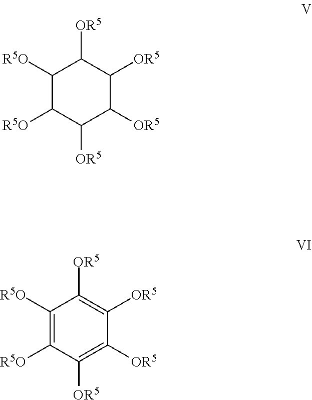

or a pharmaceutically acceptable salt thereof, wherein: R⁵ for each instance is independently hydrogen or a moiety of Formula IV:

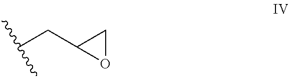 [SMILES: *CC1CO1]

with the proviso that at least 3 R⁵ is the moiety of Formula IV, thereby forming the compatibilizer, wherein the compatibilizer is a self-synthesized network-branched compatibilizing pellet represented by the by the chemical structure I or II:

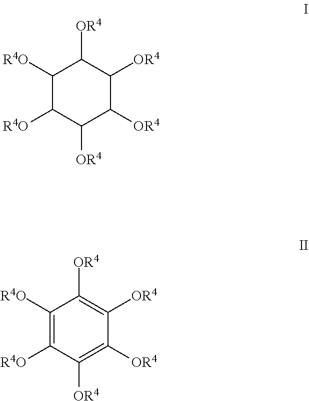

or a pharmaceutically acceptable salt thereof, wherein R⁴ for each instance is independently hydrogen, a moiety of Formula III, or a moiety of Formula IV:

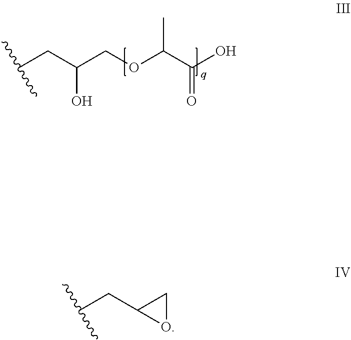

wherein q is a whole number selected from 650-6,500, with the proviso that at least 1 R⁴ is the moiety of Formula III and at least two R⁴ are the moiety of Formula IV.

The compound of Formula V or VI can be readily prepared by reaction of hexahydroxycyclohexane or hexahydroxyphenol and epichlorohydrin in the presence of a base, such as Hünig's base (N,N-diisopropylethylamine), ethanolamine, di-ethanolamine, tri-ethanolamine, dimethylethanolamine (DMEA), pyridine, pyrazine, trimethylamine (TMA), triethylamine (TEA), morpholine, N-methyl morpholine, piperdine, piperazine, pyrrolidine, 1,4-diazabicyclo[2.2.2]octane (DABCO), imidazole, N-methylmorpholine, NaOH, CsOH, LiOH, NaOH, KOH, Na₂CO₃, K₂CO₃, Cs₂CO₃, LiOrBu, NaO/Bu, KO/Bu, and the like.

### Example 1

Crush biobased materials wood to small size 80-200 mesh. Dry the biobased material powders at 100-130° C. for 3 hrs. Dry polylactic acid (PLA) (average molecular weight 85,000 amu) at 60-90° C. for 3 hrs. Add 30.0% polylactic acid (PLA), 49.5% wood powder, 12.0% polybutylene adipate terephthalate grafted maleic anhydride (PBAT-g-MAH) (average molecular weight 120,000 amu), 0.7% epoxidized soybean oil (ESO), 0.3% neopentyl glycol diglycidyl ether (NGDE), 1.0% tannic acid (TA), 0.2% ADR4368C (average molecular weight 6,800 amu), 0.8% ADR4300 (average molecular weight 5,500 amu), 0.5% tris-(2,4-di-tert-butyl-phenyl)-phosphite (Anti-168), 1.0% organic montmorillonite (OM), 2.0% TMC300 and 2.0% calcium carbonate (CC) into mixer at room temperature for 2 min. Put the mixture above in a twin-screw extruder with the extrusion conditions: 180° C., main screw speed 50 rpm and feed screw speed 8 rpm. After melting, extruding and granulating, the product can obtain plastic pellets. Dry the pellet at 80° C. for 3 hrs. The pellet can be fabricated in different commercial products by injection method. Conditions: 180° C., 50 BAR. The injected products should be annealed at 90° C. for 3 min to obtain high crystallinity and heat resistance final products.

### Example 2

Crush biobased materials bamboo to small size 80-200 mesh. Dry the biobased material powders at 100-130° C. for 3 hrs. Dry PLA (average molecular weight 150,000 amu) at 60-90° C. for 3 hrs. Add 45.0% PLA, 37.3% bamboo powder, 10.0% polylactic acid grafted maleic anhydride (PLA-g-MAH) (average molecular weight 100,000 amu), 0.4% diethylene glycol diglycidyl ether (DGDE), 0.3% 1,4-butanediol diglycidyl ether (BDE), 1.0% gallic acid (GA), 0.4% ADR4300 (average molecular weight 5,500 amu), 0.6% ADR4468 (average molecular weight 7,250 amu), 1.0% Anti-1010, 2.0% OM, 1.0% TMC300 and 1.0% CC into mixer at room temperature for 2 min. Put the mixture above in a twin-screw extruder with the extrusion conditions: 190° C., main screw speed 70 rpm and feed screw speed 7 rpm. After melting, extruding and granulating, the product can obtain plastic pellets. Dry the pellet at 80° C. for 3 hrs. The pellet can be fabricated in different commercial products by injection method. Conditions: 190° C., 45 BAR. The injected products should be annealed at 90° C. for 3 min to obtain high crystallinity and heat resistance final products.

### Example 3

Crush biobased materials corncob to small size 80-200 mesh. Dry the biobased material powders at 100-130° C. for 3 hrs. Dry PLA (average molecular weight 250,000 amu) at 60-90° C. for 3 hrs. Add 60.0% PLA, 21.6% corncob powder, 5.0% PLA-g-MAH, 5.0% PBAT-g-MAH (average molecular weight 200,000 amu), 0.9% ESO, 0.1% DE, 0.8% DB, 0.3% ADR4368C (average molecular weight 6,800 amu), 0.3% ADR4468 (average molecular weight 7,250 amu), 0.4% Anti-168, 0.6% Anti-1010, 1.0% OM, 1.0% TMC300 and 3.0% CC into mixer at room temperature for 2 min. Put the mixture above in a twin-screw extruder with the extrusion conditions: 200° C., main screw speed 80 rpm and feed screw speed 6 rpm. After melting, extruding and granulating, the product can obtain plastic pellets. Dry the pellet at 80° C. for 3 hrs. The pellet can be fabricated in different commercial products by injection method. Conditions: 200° C., 40 BAR. The injected products should be annealed at 90° C. for 3 min to obtain high crystallinity and heat resistance final products.

### Example 4

Crush biobased materials wood to small size 80-200 mesh. Dry the biobased material powders at 100-130° C. for 3 hrs. Dry PLA (average molecular weight 400,000 amu) at 60-90° C. for 3 hrs. Add 40.0% PLA, 40.8% wood powder, 7.0% PBAT-g-MAH (average molecular weight 300,000 amu), 0.2% NGDE, 0.4% DGDE, 0.1% BDE, 0.5% pyrogallol, 1.0% ADR4368C (average molecular weight 6,800 amu), 0.2% Anti-168, 0.8% Anti-1010, 1.0% OM, 3.0% TMC300 and 5.0% CC into mixer at room temperature for 2 min. Put the mixture above in a twin-screw extruder with the extrusion conditions: 180° C., main screw speed 75 rpm and feed screw speed 7 rpm. After melting, extruding and granulating, the product can obtain plastic pellets. Dry the pellet at 90° C. for 3 hrs. The pellet can be fabricated in different commercial products by injection method. Conditions: 180° C., 50 BAR. The injected products should be annealed at 90° C. for 3 min to obtain high crystallinity and heat resistance final products.

### Example 5

The network-branched compatibilizer uses 1 mol hexahydroxycyclohexane as the starting material and reacts with 7.2 mol epichlorohydrin under alkaline conditions (12 mol triethylamine in acetone, 70° C., 3.5 hrs). In a twin-screw extruder, by melting and extruding (180-200° C., 50 rpm) a certain proportion of network-branched compatibilizer with PLA (mol ratio 1/3), the epoxy groups on the compatibilizer will react with the terminal hydroxyl groups of PLA, thereby preparing network-branched compatibilizing pellet.

Crush biobased materials bamboo to small size 80-200 mesh. Dry the biobased material powders at 100-130° C. for 3 hrs. Dry PLA at 60-90° C. for 3 hrs. Add 50.0% PLA, 32.0% bamboo powder, 8.0% self-synthesized network-branched compatibilizing pellet, 0.2% TA, 0.5% GA, 0.1% DB, 0.5% pyrogallol, 0.3% ADR4368C, 0.3% ADR4300, 0.4% ADR4468, 0.3% Anti-168, 0.4% Anti-1010, 3.0% OM, 1.0% TMC300 and 3.0% CC into mixer at room temperature for 2 min. Put the mixture above in a twin-screw extruder with the extrusion conditions: 180° C., main screw speed 75 rpm and feed screw speed 7 rpm. After melting, extruding and granulating, the product can obtain plastic pellets. Dry the pellet at 90° C. for 3 hrs. The pellet can be fabricated in different commercial products by injection method. Conditions: 180° C., 50 BAR. The injected products should be annealed at 90° C. for 3 min to obtain high crystallinity and heat resistance final products.

TABLE 1

| | Tensile Strength | Flexural Strength | Heat Resistance |
|---|---|---|---|
| Examples | (MPa) | (MPa) | Temperature (° C.) |
| Example 1 | 33.8 | 52.3 | 80 |
| Example 2 | 47.5 | 70.8 | 86 |
| Example 3 | 53.0 | 81.5 | 88 |
| Example 4 | 42.6 | 64.2 | 83 |
| Example 5 | 61.4 | 95.0 | 95 |

What is claimed is:

1. A polylactic acid (PLA)/biomass composite comprising: polylactic acid (PLA), a biomass material, a compatibilizer, a crosslinker, a chain extender, an antioxidant, and a nucleating agent, wherein the PLA, the biomass material, the compatibilizer, the crosslinker, the chain extender, the antioxidant, and the nucleating agent are present in the PLA/biomass composite at a concentration of 30-60% wt/wt, 20-70% wt/wt, 5-20% wt/wt, 0.1-3% wt/wt, 0.1-2% wt/wt, 0.1-1% wt/wt, and 1-10% wt/wt, respectively.

2. The PLA/biomass composite of claim 1, wherein the biomass material is selected from the group consisting of wood, bamboo, corncob, and combinations thereof.

3. The PLA/biomass composite of claim 1, wherein the compatibilizer is selected from polylactic acid grafted maleic anhydride (PLA-g-MAH); polybutylene adipate terephthalate grafted maleic anhydride (PBAT-g-MAH); a self-synthesized network-branched compatibilizing pellet represented by the by the chemical structure I or II: 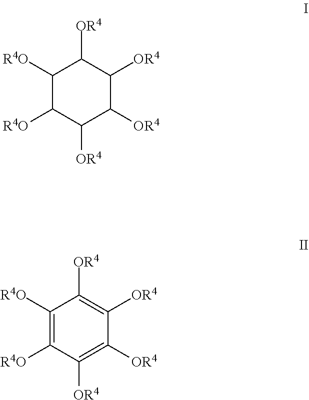
or a pharmaceutically acceptable salt thereof, wherein: R⁴ for each instance is independently hydrogen, a moiety of Formula III, or a moiety of Formula IV: 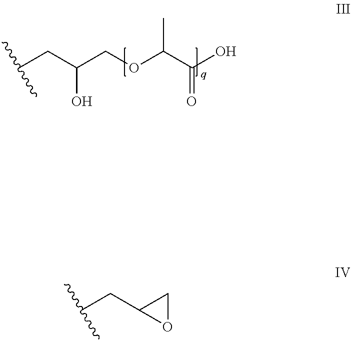
wherein q is a whole number selected from 650-6,500, with the proviso that at least 1 R⁴ is the moiety of Formula III and at least two R⁴ are the moiety of Formula IV; and combinations thereof.

4. The PLA/biomass composite of claim 1, wherein the crosslinker is selected from the group consisting of epoxidized soybean oil (ESO), neopentyl glycol diglycidyl ether (NGDE), diethylene glycol diglycidyl ether (DGDE), 1,4-butanediol diglycidyl ether (BDE), diglycidyl ether (DE), tannic acid (TA), gallic acid (GA), 3,4-dihydroxybenzaldehyde (DB), pyrogallol, and combinations thereof.

5. The PLA/biomass composite of claim 1, wherein the chain extender is selected from the group consisting of: 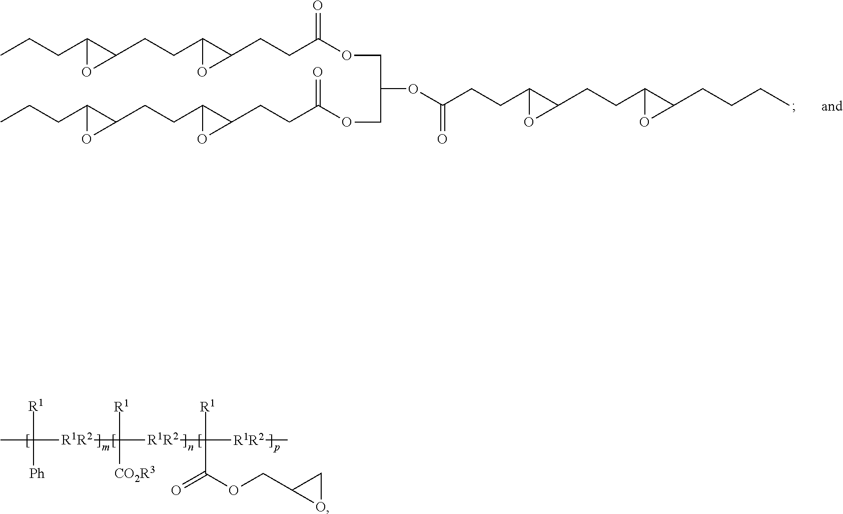
wherein each of R¹ and R² is independently H, CH₃, or alkyl; R³ is alkyl, and each of m, n, and p is independently 1-20; and combinations thereof.

6. The PLA/biomass composite of claim 1, wherein the antioxidant is selected from the group consisting of: 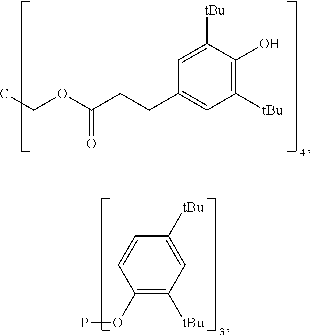
and combinations thereof.

7. The PLA/biomass composite of claim 1, wherein the nucleating agent is selected from the group consisting of: sebacic acid diphenyl dihydrazide, montmorillonite, calcium carbonate, and combinations thereof.

8. The PLA/biomass composite of claim 3, wherein the crosslinker is selected from the group consisting of epoxidized soybean oil (ESO), neopentyl glycol diglycidyl ether (NGDE), diethylene glycol diglycidyl ether (DGDE), 1,4-butanediol diglycidyl ether (BDE), diglycidyl ether (DE), tannic acid (TA), gallic acid (GA), 3,4-dihydroxybenzaldehyde (DB), pyrogallol, and combinations thereof; the chain extender is selected from the group consisting of: 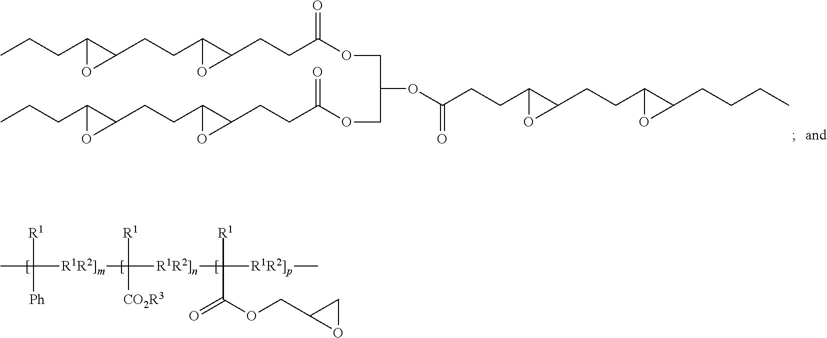
wherein each of R¹ and R² is independently H, CH₃, or alkyl; R³ is alkyl, and each of m, n, and p is independently 1-20; and combinations thereof;
the antioxidant is selected from the group consisting of: 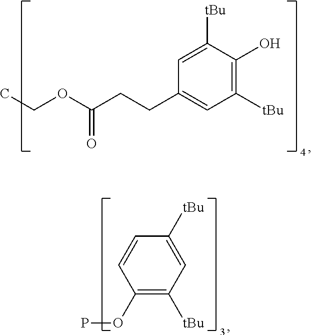
and combinations thereof; and the nucleating agent is selected from the group consisting of: sebacic acid diphenyl dihydrazide, montmorillonite, calcium carbonate, and combinations thereof.

9. The PLA/biomass composite of claim 8, wherein the PLA, the biomass material, the compatibilizer, the crosslinker, the chain extender, the antioxidant, and the nucleating agent are present in the PLA/biomass composite at a concentration of 30-60% wt/wt, 21.6-49.5% wt/wt, 8-12% wt/wt, 1.2-2% wt/wt, 0.6-1% wt/wt, 0.5-1% wt/wt, and 4-9% wt/wt, respectively.

10. The PLA/biomass composite of claim 1, wherein the compatibilizer is a self-synthesized network-branched compatibilizing pellet represented by the by the chemical structure I or II: 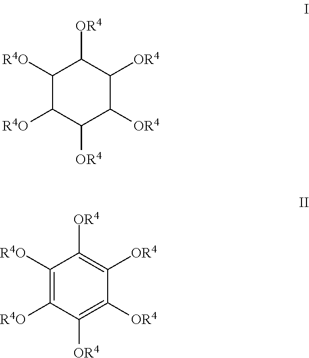
or a pharmaceutically acceptable salt thereof, wherein: R⁴ for each instance is independently hydrogen, a moiety of Formula III, or a moiety of Formula IV: 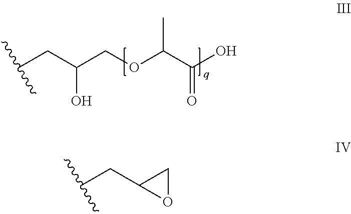
wherein q is a whole number selected from 650-6,500, with the proviso that at least 1 R⁴ is the moiety of Formula III and at least two R⁴ are the moiety of Formula IV; and combinations thereof;
the crosslinker comprises tannic acid, gallic acid, 3,4-dihydroxybenzaldehyde, and pyrogallol; the chain extender comprises: 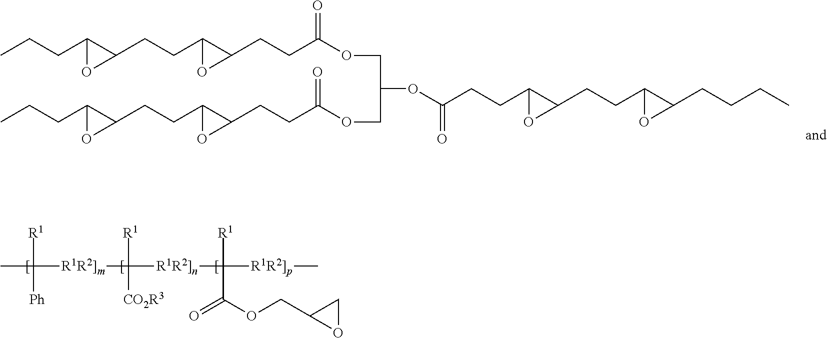
wherein each of R¹ and R² is independently H, CH₃, or alkyl; R³ is alkyl, and each of m, n, and p is independently 1-20;
the antioxidant comprises: 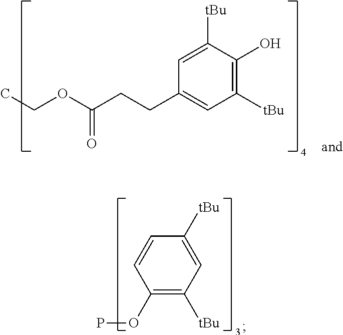
and the nucleating agent comprises sebacic acid diphenyl dihydrazide, montmorillonite, and calcium carbonate.

11. The PLA/biomass composite of claim 10, wherein the PLA, the biomass material, the compatibilizer, the crosslinker, the chain extender, the antioxidant, and the nucleating agent are present in the PLA/biomass composite at a concentration of about 50% wt/wt, about 32% wt/wt, about 8% wt/wt, about 1.3% wt/wt, about 1% wt/wt, about 0.7% wt/wt, and about 7% wt/wt, respectively.

12. A method of preparing the PLA/biomass composite of claim 1, the method comprising: melt blending PLA, the biomass material, the compatibilizer, the crosslinker, the chain extender, the antioxidant, and the nucleating agent; optionally pelletizing and optionally drying thereby forming the PLA/biomass composite.

13. The method of claim 12, wherein the biomass material is selected from the group consisting of wood, bamboo, corncob, and combinations thereof.

14. The method of claim 12, wherein the compatibilizer is selected from polylactic acid grafted maleic anhydride (PLA-g-MAH); polybutylene adipate terephthalate grafted maleic anhydride (PBAT-g-MAH); a self-synthesized network-branched compatibilizing pellet represented by the by the chemical structure I or II: 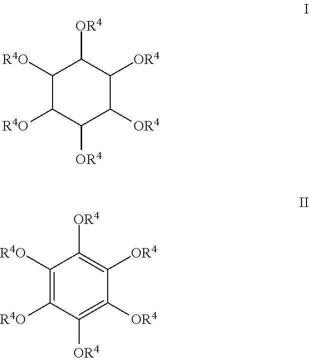
or a pharmaceutically acceptable salt thereof, wherein: R⁴ for each instance is independently hydrogen, a moiety of Formula III, or a moiety of Formula IV: 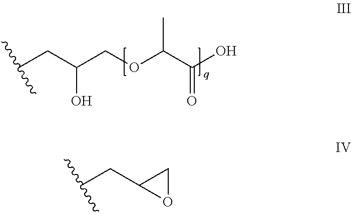
wherein q is a whole number selected from 650-6,500, with the proviso that at least 1 R⁴ is the moiety of Formula III and at least two R⁴ are the moiety of Formula IV; and combinations thereof.

15. The method of claim 12, wherein the crosslinker is selected from the group consisting of epoxidized soybean oil (ESO), neopentyl glycol diglycidyl ether (NGDE), diethylene glycol diglycidyl ether (DGDE), 1,4-butanediol diglycidyl ether (BDE), diglycidyl ether (DE), tannic acid (TA), gallic acid (GA), 3,4-dihydroxybenzaldehyde (DB), pyrogallol, and combinations thereof.

16. The method of claim 12, wherein the chain extender is selected from the group consisting of: 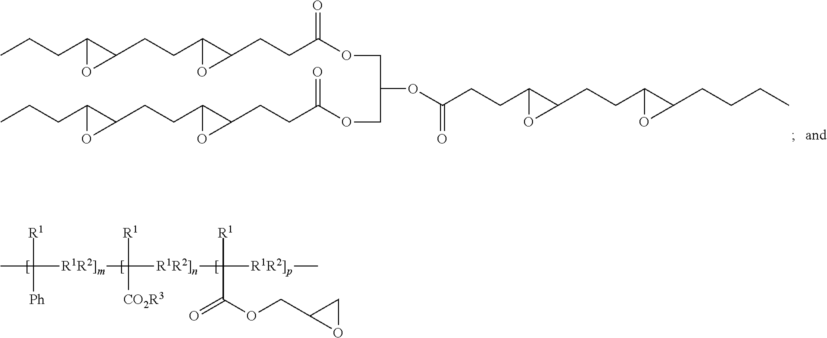
wherein each of R¹ and R² is independently H, CH₃, or alkyl; R³ is alkyl, and each of m, n, and p is independently 1-20; and combinations thereof.

17. The method of claim 12, further comprising: contacting PLA with a compound of Formula V or VI: 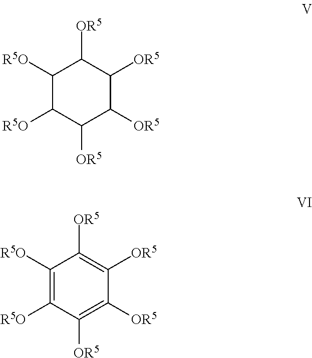
or a pharmaceutically acceptable salt thereof, wherein: R⁵ for each instance is independently hydrogen or a moiety of Formula IV: 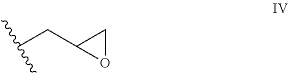 [SMILES: *CC1CO1]
with the proviso that at least 3 R⁵ is the moiety of Formula IV, thereby forming the compatibilizer, wherein the compatibilizer is a self-synthesized network-branched compatibilizing pellet represented by the by the chemical structure I or II: 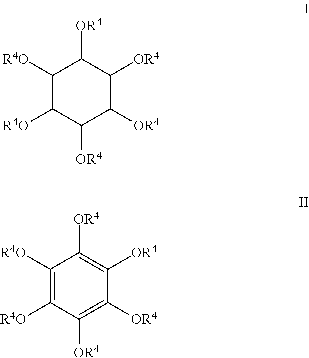
or a pharmaceutically acceptable salt thereof, wherein R⁴ for each instance is independently hydrogen, a moiety of Formula III, or a moiety of Formula IV: 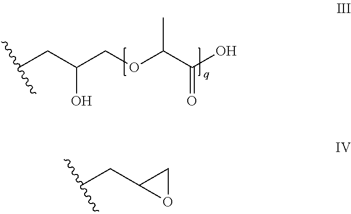
wherein q is a whole number selected from 650-6,500, with the proviso that at least 1 R⁴ is the moiety of Formula III and at least two R⁴ are the moiety of Formula IV.

18. The method of claim 17, wherein the method comprises melt blending PLA and the compound of Formula V or VI, thereby forming the self-synthesized network-branched compatibilizing pellet; and melt blending the self-synthesized network-branched compatibilizing pellet with PLA, the biomass material, crosslinker, antioxidant, and nucleating agent, optionally pelletizing, and optionally drying thereby forming the PLA/biomass composite.

19. The method of claim 18, wherein the PLA and the compound of Formula V or VI are melt extruded at 160-190° C. thereby forming the network-branched compatibilizing pellet; and the network-branched compatibilizing pellet, PLA, the biomass material, antioxidant, and nucleating agent are melt extruded at 190-220° C.; optionally pelletizing and optionally drying thereby forming the PLA/biomass composite.

20. The method of claim 17, wherein the crosslinker comprises tannic acid, gallic acid, 3,4-dihydroxybenzaldehyde, and pyrogallol; the chain extender comprises: 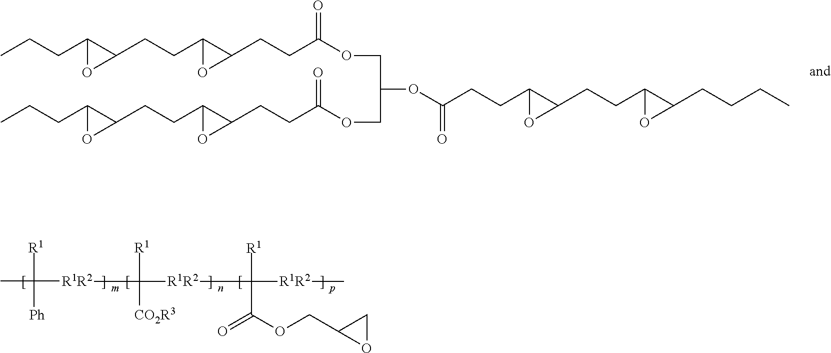
wherein each of R¹ and R² is independently H, CH₃, or alkyl; R³ is alkyl, and each of m, n, and p is independently 1-20;
the antioxidant comprises: 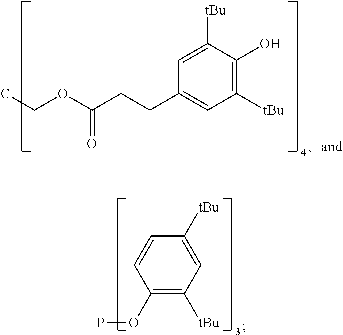
and the nucleating agent comprises sebacic acid diphenyl dihydrazide, montmorillonite, and calcium carbonate.
